(19) United States
(12) Patent Application Publication
(10) Pub. No.: US 2012/0229685 A1
(43) Pub. Date: Sep. 13, 2012

(54) ELECTRONIC APPARATUS AND DISPLAY METHOD

(75) Inventor: Kotaro Fukui, Hamura-shi (JP)

(73) Assignee: KABUSHIKI KAISHA TOSHIBA, Tokyo (JP)

(21) Appl. No.: 13/406,865

(22) Filed: Feb. 28, 2012

(30) Foreign Application Priority Data
Mar. 8, 2011 (JP) 2011-050844

(51) Int. Cl. H04N 5/222

(52) U.S. Cl. 348/333.01; 348/E05.022

(57) ABSTRACT

An electronic apparatus includes an image data receiving module, a color data acquiring module, and a video display module. The image data receiving module is configured to receive image data that is produced by a camera through shooting. The color data acquiring module is configured to acquire color data of a color that is close to a complementary color of a color of the received image data. The video display module is configured to display a first image based on the received image data and to display a second image adjacent to the first image based on the acquired color data.

### CROSS REFERENCE TO RELATED APPLICATION(S)

The present disclosure relates to the subject matters contained in Japanese Patent Application No. 2011-050844 filed on Mar. 8, 2011, which are incorporated herein by reference in its entirety.

### FIELD

An exemplary embodiment of the present invention relates to an electronic apparatus and a display method.

### BACKGROUND

In recent years, electronic apparatus such as personal computers (PCs) and cell phones which can display an image (shot image) taken by a camera on a video display unit (display device) as a preview, for example.

Such electronic apparatus can also send and receive an image taken by a camera over the Internet, for example.

However, a dark shot image may be displayed if shooting is performed in a dark environment and no auxiliary light source (e.g., flash lamp) is available.

An auxiliary light source is not necessarily available when shooting is performed. And if shooting is performed in a dark environment without flashing, a dark shot image is obtained and a dark preview may be displayed on a video display unit (display device). This results in a problem that the user has difficulty recognizing the shot image visually, which is inconvenient.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 shows an appearance of a notebook PC according to an embodiment.

FIG. 2 is a block diagram showing the configuration of the notebook PC according to the embodiment.

FIG. 3 shows an example camera-shot image displayed on the notebook PC according to the embodiment.

FIG. 4 shows an example camera-shot image displayed on a notebook PC according to another embodiment.

FIG. 5 shows an example camera-shot image displayed on a notebook PC according to still another embodiment.

FIG. 6 shows an example camera-shot image displayed on a notebook PC according to a further embodiment.

FIG. 7 is a flowchart of a process which is executed by each of the notebook PCs according to the embodiments.

FIG. 8 is a flowchart of a luminance control process using an illuminance sensor which is executed by each of the notebook PCs according to the embodiments.

### DETAILED DESCRIPTION OF THE EMBODIMENTS

According to an exemplary embodiment, there is provided an electronic apparatus including an image data receiving module, a color data acquiring module, and a video display module. The image data receiving module is configured to receive image data that is produced by a camera through shooting. The color data acquiring module is configured to acquire color data of a color that is close to a complementary color of a color of the received image data. The video display module is configured to display a first image based on the received image data and to display a second image adjacent to the first image based on the acquired color data.

An exemplary embodiment will be hereinafter described with reference to the drawings.

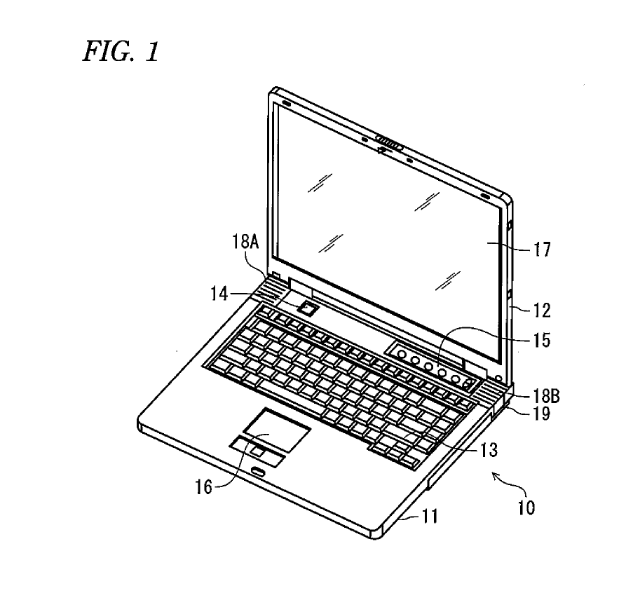

FIG. 1 shows an appearance of an electronic apparatus according to the embodiment, which is a notebook personal computer (PC) 10.

The application of exemplary embodiment of the invention is not limited to notebook PCs as shown in FIG. 1, and the exemplary embodiment can also be applied to slate PCs, TV receivers, cell phones, other portable electronic apparatus, and the like.

As shown in FIG. 1, the notebook PC 10 is configured of a computer main body 11 and a video display unit 12. The display unit 12 incorporates a liquid crystal display (LCD) 17, for example.

The display unit 12 is attached to the computer main body 11 so as to be rotatable between an open position where it exposes the top surface of the computer main body 11 and a closed position where it covers the top surface of the computer main body 11.

The computer main body 11 has a thin, box-shaped cabinet, and its top surface is provided with a keyboard 13, a power button 14 for powering on and off the notebook PC 10, an input manipulation panel 15, a touch pad 16, speakers 18A and 18B, etc. Various manipulation buttons are provided on the input manipulation panel 15.

The right-hand side surface of the computer main body 11 is provided with a universal serial bus (USB) connector 19 to which a USB cable or a USB device that complies with the universal serial bus (USB) 2.0 standard, for example, is to be connected.

The back surface of the computer main body 11 is provided with an external display connection terminal (not shown) that complies with the high-definition multimedia interface (HDMI) standard, for example. The external display connection terminal is used for outputting a digital video signal to an external display.

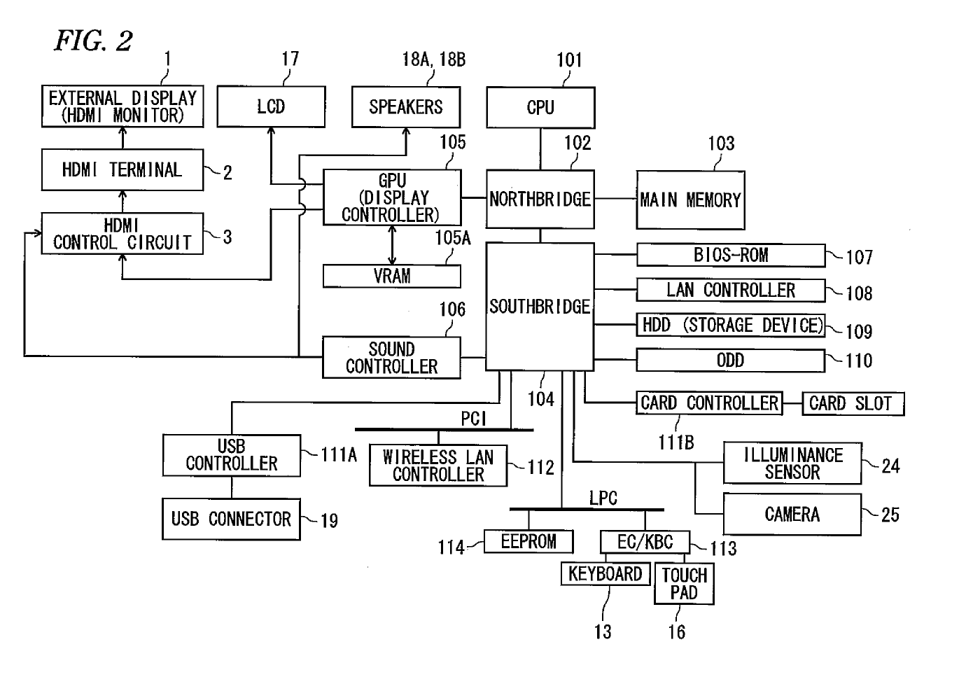

FIG. 2 is a block diagram showing the configuration of the notebook PC 10 according to the embodiment. As shown in FIG. 2, the notebook PC 10 is equipped with a central processing unit (CPU) 101, a northbridge 102, a main memory 103, a southbridge 104, a graphics processing unit (GPU) 105, a video random access memory (VRAM) 105A, a sound controller 106, a basic input/output system-read only memory (BIOS-ROM) 107, a local area network (LAN) controller 108, a hard disk drive (HDD; storage device) 109, an optical disc drive (ODD) 110, a USB controller 111A, a card controller 111B, a wireless LAN controller 112, an embedded controller/keyboard controller (EC/KBC) 113, an electrically erasable programmable ROM (EEPROM) 114, etc.

The CPU 101 is a processor which controls operations of individual components of the notebook PC 10. The CPU 101 runs a BIOS which is stored in the BIOS-ROM 107. The BIOS is programs for hardware control.

The northbridge 102 is a bridge device which connects a local bus of the CPU 101 to the southbridge 104. The northbridge 102 incorporates a memory controller for access-controlling the main memory 103. The northbridge 11 also has a function of performing a communication with the GPU 105 via, for example, a serial bus that complies with the PCI Express standard.

The GPU 105 is a display controller which controls the LCD 17 which is used as a display monitor of the notebook PC 10. A display signal generated by the GPU 105 is sent to the LCD 17. The GPU 105 can also send a digital video signal to an external display 1 via an HDMI control circuit 3 and an HDMI terminal 2.

The HDMI terminal 2 is the above-mentioned external display connection terminal. The HDMI terminal 2 can send a non-compressed digital video signal and digital audio signal to the external display 1 such as a TV receiver via a single cable. The HDMI control circuit 3 is an interface for sending a digital video signal to the external display (called an HDMI monitor) via the HDMI terminal 2.

The southbridge 104 controls the individual devices on a peripheral component interconnect (PCI) bus and the individual devices on a low pin count (LPC) bus. The southbridge 104 incorporates an integrated drive electronics (IDE) controller for controlling the HDD 109 and the ODD 110.

The southbridge 104 also has a function of controlling a communication with the sound controller 106.

The sound controller 106, which is a sound source device, outputs reproduction subject audio data to the speakers 18A and 18B or the HDMI control circuit 3. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example. The USB controller 111A performs a communication with an external device (connected to the USB connector 19) which complies with the USB 2.0 standard, for example.

For example, the USB controller 111A is used for receiving an image data file from a digital camera. The card controller 111B writes and reads data to and from a memory card such as an SD card that is inserted in a card slot that is formed in the computer main body 11.

The EC/KBC 113 is a one-chip microcomputer in which an embedded controller for power management and a keyboard controller for controlling the keyboard 13 and the touch pad 16 are integrated together. The EC/KBC 113 has a function of powering on and off the notebook PC 10 in response to a user manipulation of the power button 14.

In the embodiment, display control is performed in such a manner that, for example, the CPU 101 runs a program stored in the main memory 103, the HDD 109, or the like.

In the embodiment, the notebook PC 10 is equipped with an illuminance sensor 24 and a camera 25 which are connected to the southbridge 104, for example.

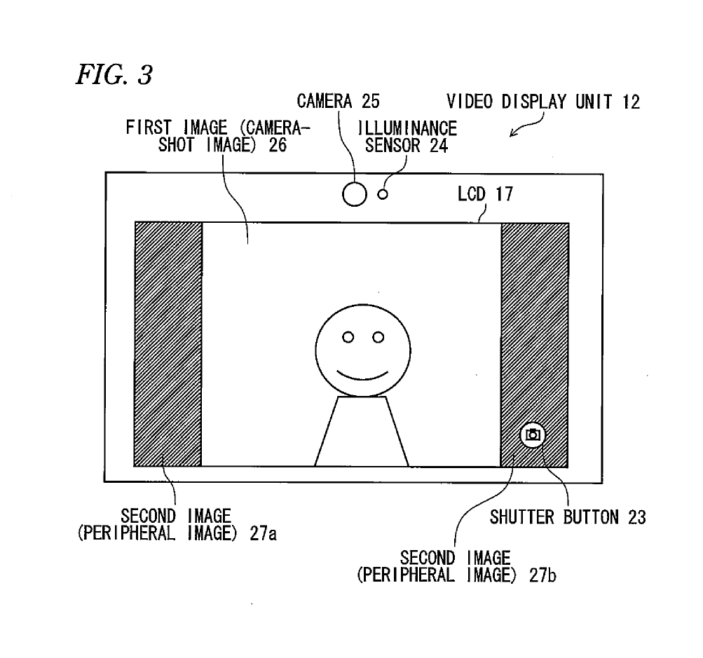

FIG. 3 shows an example camera-shot image displayed on the notebook PC 10 according to the embodiment. For example, as shown in FIG. 3, the display unit 12 of the notebook PC 10 is provided with the LCD 17, a shutter button 23, the illuminance sensor 24, and the camera 25.

In the embodiment, for example, a first image (camera-shot image) 26, second images (peripheral images) 27a are displayed on the LCD 17.

In the embodiment, when the user switches on the shutter button 23 by manipulating the keyboard 13 or the touch pad 16, the camera 25 starts shooting.

A shot image (image data) taken by and output from the camera 25 is received by the southbridge 104, for example.

Then, for example, processing of simplifying the image data is performed under the control of the CPU 101. For example, processing of plotting pieces of color information of the image data and averaging them is performed. That is, pieces of color information are acquired from the image data and averaged to calculate an average color (monochrome color).

Then, color data representing a color that is close to a substantial complementary color of the calculated average color is acquired using a complementary color table (not shown) which is stored in the main memory 103 in advance.

The complementary color will be described below. Complementary colors are a pair of colors that are located at opposite positions in the color circle. For example, green is complementary to red, purple is complementary to yellow, and orange is complementary to blue.

Complementary colors have a synergy effect of complementing each other (called a complementary color harmony).

In the embodiment, data of a color that is close to a substantial complementary color of a calculated average color is acquired using the complementary color table stored in the main memory 103.

In the embodiment, as shown in FIG. 3, for example, a first image 26 which is a shot image of the camera 25 is displayed on the LCD 17 using received image data.

In the embodiment, as shown in FIG. 3, a second image is displayed on the LCD 17 adjacent to the first image 26 using the data of the color that is close to the substantial complementary color of the calculated average color. That is, the second image is displayed based on the color data of the color that is close to the substantial complementary color of the color of the first image (i.e., the camera-shot image, the image data).

More specifically, in the embodiment, the first image 26 is displayed at the center of the display screen of the LCD 17 and the second images (peripheral images) 27a and 27b are displayed adjacent to (i.e., on the left and right of) the first image 26 based on color data of the color that is close to the substantial complementary color of the average color of the first image 26.

In the embodiment, if the average color of the first image 26 is a color that is close to blue, for example, data of a color that is close to orange which is the complementary color of blue is acquired from the complementary color table as described above and second images 27a and 27b having the color that is close to orange are displayed.

Likewise, when the average color of the first image 26 is a color that is close to red, second images 27a and 27b having a color that is close to green are displayed. When the average color of the first image 26 is a color that is close to yellow, second images 27a and 27b having a color that is close to purple are displayed.

In the embodiment, a first image (camera-shot image) 26 is displayed on the LCD 17 and second images (peripheral images) 27a and 27b are display adjacent to (on the left and right of) the first image 26. And the average color, for example, of the first image 26 varies every time another image is taken. The color of the second images 27a and 27b which are displayed adjacent to the first image 26 is also varied according to the average color of the first display 26 in such a manner that the above-described relationship is satisfied.

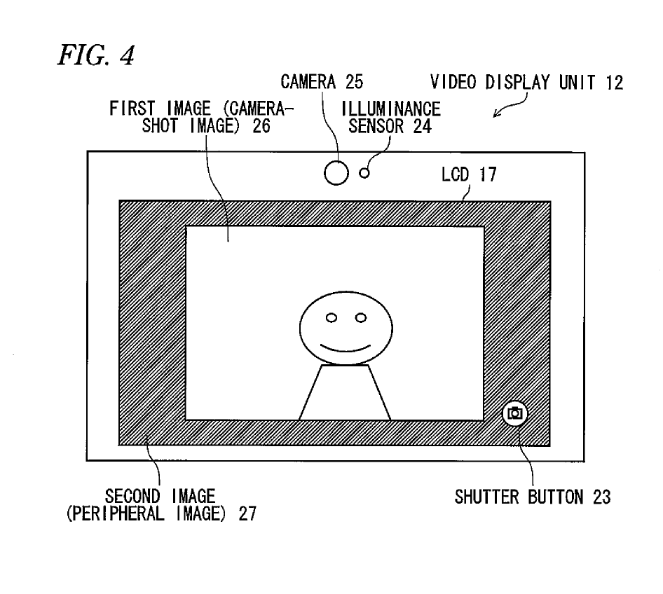

FIG. 4 shows an example camera-shot image displayed on a notebook PC according to another embodiment. In this embodiment, a first image (camera-shot image) 26 is displayed at the center of the display screen of the LCD 17 and a second image (peripheral image) 27 is displayed around the first image 26 so as to surround the first image 26.

In this embodiment, as in the embodiment of FIG. 3, the second image 27 is displayed in a color that is close to a substantial complementary color of an average color of the first image 26.

That is, in the embodiment, when the average color of the first image 26 is a color that is close to blue, for example, data of a color that is close to orange which is the complementary color of blue is acquired from the complementary color table as described above and a second image 27 having the color that is close to orange is displayed.

Likewise, when the average color of the first image 26 is a color that is close to red, a second image 27 having a color that is close to green is displayed. When the average color of the first image 26 is a color that is close to yellow, a second image 27 having a color that is close to purple is displayed.

In the embodiment, a first image (camera-shot image) 26 is displayed on the LCD 17 and a second image (peripheral image) 27 is display around the first image 26. And the average color, for example, of the first image 26 varies every time another image is taken. The color of the second image 27 which is displayed around the first image 26 is also varied according to the average color of the first display 26 in such a manner that the above-described relationship is satisfied.

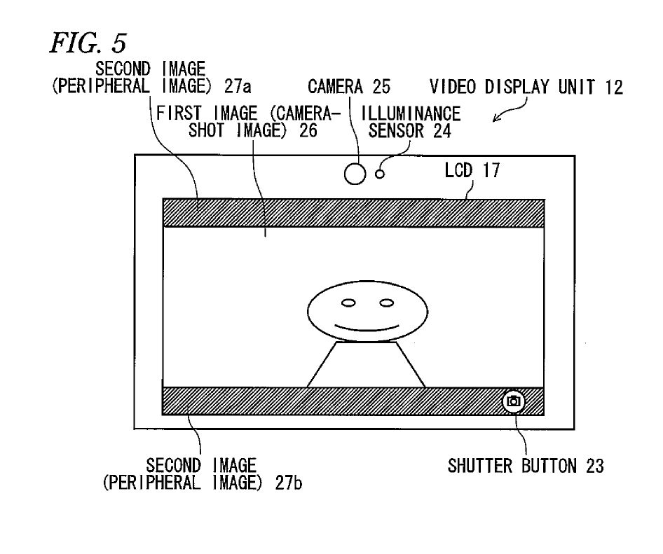

FIG. 5 shows an example camera-shot image displayed on a notebook PC according to still another embodiment. In this embodiment, a first image (camera-shot image) 26 is displayed at the center of the display screen of the LCD 17 and second images (peripheral images) 27a and 27b are displayed adjacent to (i.e., over and under) the first image 26 on the basis of data of a color that is close to a substantial complementary color of an average color of the first image 26.

In the embodiment, when the average color of the first image 26 is a color that is close to blue, for example, data of a color that is close to orange which is the complementary color of blue is acquired from the complementary color table as described above and second images 27a and 27b having the color that is close to orange are displayed.

Likewise, when the average color of the first image 26 is a color that is close to red, second images 27a and 27b having a color that is close to green are displayed. When the average color of the first image 26 is a color that is close to yellow, second images 27a and 27b having a color that is close to purple are displayed.

In the embodiment, a first image (camera-shot image) 26 is displayed on the LCD 17 and second images (peripheral images) 27a and 27b are display adjacent to (over and under) the first image 26. And the average color, for example, of the first image 26 varies every time another image is taken. The color of the second images 27a and 27b which are displayed adjacent to the first image 26 is also varied according to the average color of the first display 26 in such a manner that the above-described relationship is satisfied.

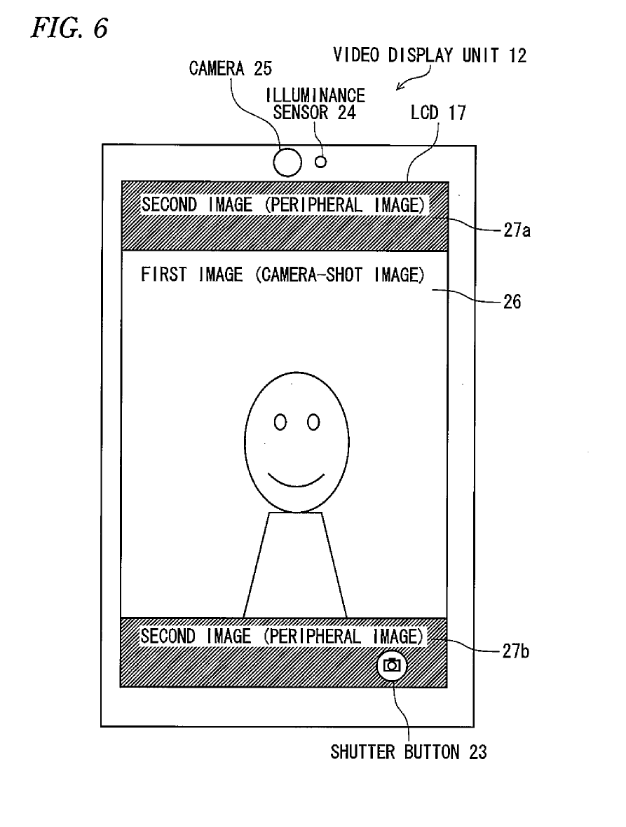

FIG. 6 shows an example camera-shot image displayed on a notebook PC according to a further embodiment. Whereas in the above embodiments the first image 26 is displayed on the display screen of the LCD 17 which is long in the horizontal direction, in this embodiment the display screen of an LCD 17 which is long in the vertical direction is used.

In this embodiment, a first image (camera-shot image) 26 is displayed at the center of the display screen of the LCD 17 which is long in the vertical direction. And second images (peripheral images) 27a and 27b are displayed adjacent to (i.e., over and under) the first image 26 on the basis of data of a color that is close to a substantial complementary color of an average color of the first image 26.

In the embodiment, if the average color of the first image 26 is a color that is close to blue, for example, data of a color that is close to orange which is the complementary color of blue is acquired from the complementary color table as described above and second images 27a and 27b having the color that is close to orange are displayed.

Likewise, if the average color of the first image 26 is a color that is close to red, second images 27a and 27b having a color that is close to green are displayed. If the average color of the first image 26 is a color that is close to yellow, second images 27a and 27b having a color that is close to purple are displayed.

In the embodiment, a first image (camera-shot image) 26 is displayed on the display screen of the LCD 17 which is long in the vertical direction and second images (peripheral images) 27a and 27b are display adjacent to (over and under) the first image 26. And the average color, for example, of the first image 26 varies every time another image is taken. The color of the second images 27a and 27b which are displayed adjacent to the first image 26 is also varied according to the average color of the first display 26 in such a manner that the above-described relationship is satisfied.

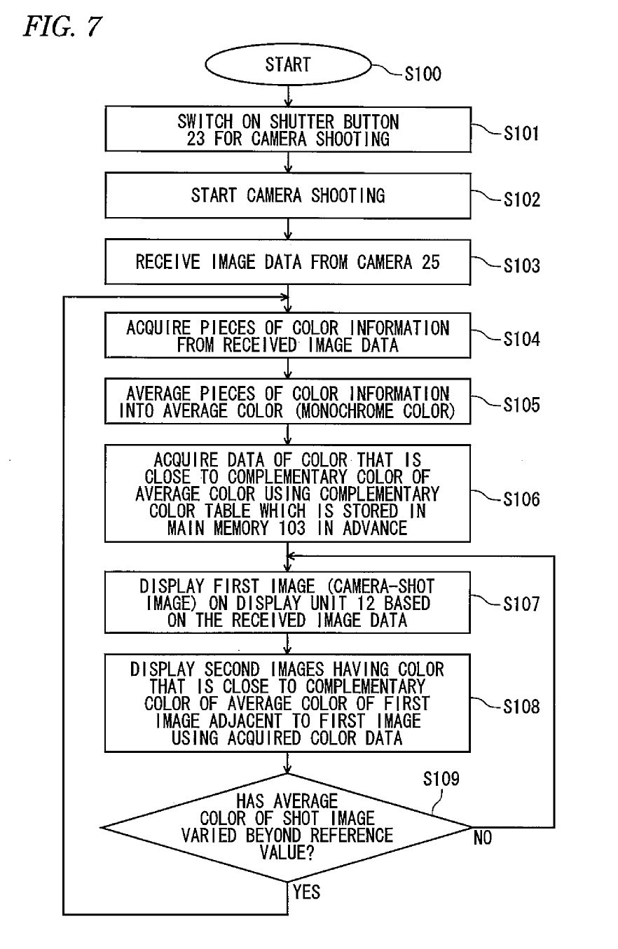

FIG. 7 is a flowchart of a process which is executed by each of the notebook PCs 10 according to the embodiments.

The process starts at step S100. At step S101, for example, the user switches on the shutter button 23 for camera shooting by manipulating the keyboard 13 or the touch pad 16.

At step S102, shooting is started using the camera 25 of the notebook PC 10. The camera 25 outputs image data produced.

At step S103, the image data that is output from the camera 25 is received by the notebook PC 10. At step S104, pieces of color information are acquired from the received image data. At step S105, the acquired pieces of color information are averaged to calculate an average color (monochrome color), for example. At step S106, data of a color that is close to a complementary color of the average color is acquired using the complementary color table which is stored in the main memory 103 in advance.

At step S107, a first image (camera-shot image) 26 is displayed on the display unit 12 on the basis of the acquired color data.

At step S108, second images 27a and 27b, for example, having the color that is close to the complementary color of the average color of the first image 26 are displayed adjacent to the first image 26 using the acquired color data.

At step S109, it is judged whether the average color of the shot image has varied beyond a reference value. For example, the reference value is stored in the main memory 103 in advance. When it is judged that the average color of the shot image have varied beyond the reference value, the process returns to step S104. On the other hand, when the average color of the shot image has not varied beyond the reference value, the process returns to step S107.

According to the above-described process, when the color of the first image 26 has varied, the color of the second images 27a and 27b is varied according to the varied color of the first image 26.

Since second images (peripheral images) 27a and 27b are displayed in a color that is a complementary color of an average color of a first image (camera-shot image) 26, the color of the first image 26 can be displayed as a color that is closer to a natural color.

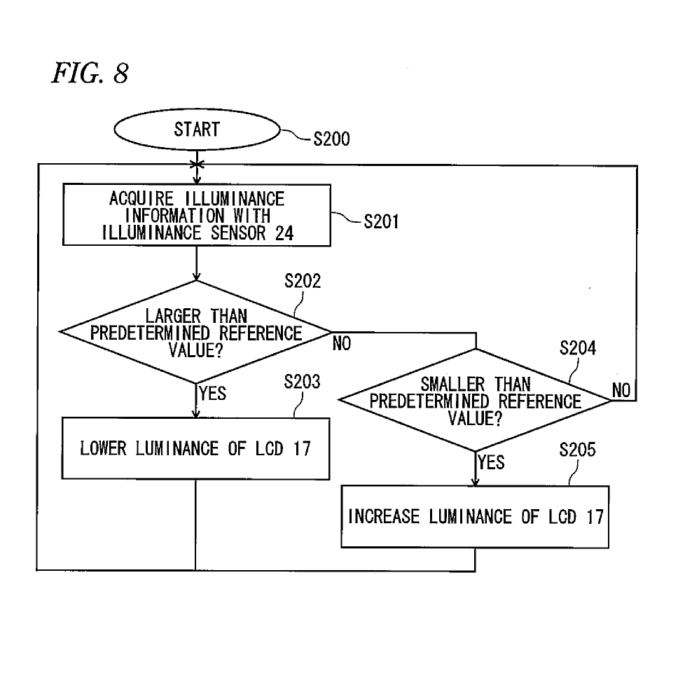

FIG. 8 is a flowchart of a luminance control process using the illuminance sensor 24 which is executed by the notebook PCs 10 according to the embodiments.

The process starts at step S200. At step S201, illuminance information is acquired by, for example, measuring illuminance with the illuminance sensor 24.

At step S202, the acquired illuminance information is compared with a predetermined reference value and it is judged whether the acquired illuminance information is larger than the predetermined reference value. When it is judged that the acquired illuminance information is larger than the predetermined reference value (S202: yes), the process moves to step S203. On the other hand, when it is not judged that the acquired illuminance information is larger than the predetermined reference value (S202: no), the process moves to step S204.

At step S203, the CPU 101, for example, instructs the GPU 105 to lower the luminance of the display screen of the LCD 17. Then, the process returns to step S201.

At step S204, the acquired illuminance information is compared with a predetermined reference value and it is judged whether the acquired illuminance information is smaller than the predetermined reference value. When it is judged that the acquired illuminance information is smaller than the predetermined reference value (S204: yes), the process moves to step S205, where the CPU 101, for example, instructs the GPU 105 to increase the luminance of the display screen of the LCD 17. On the other hand, when it is not judged that the acquired illuminance information is larger than the predetermined reference value (S204: no), the process returns to step S201.

The above process makes it possible to increase the visibility of a first image (camera-shot image) 26.

Furthermore, as mentioned above, the color of a first image 26 is displayed as a color that is closer to a natural color. And a clearer first image 26 can be displayed by controlling the luminance of the LCD 17.

Although the embodiments are directed to the case that the camera 25 is integral with the display unit 12, the embodiment of the invention is not limited to such a case. The camera 25 may be provided separately from the display unit 12.

With the above configuration, the embodiment makes it possible to increase the visibility of a displayed shot image and to thereby enhance the convenience of the user in an electronic apparatus which displays a shot image.

The invention is not limited to the above embodiments themselves and, in the practice stage, may be embodied in such a manner that constituent elements are modified without departing from the spirit and scope of the invention. And various inventions can be conceived by properly combining plural constituent elements disclosed in each embodiment. For example, several ones of the constituent elements of each embodiment may be omitted. Furthermore, constituent elements of different embodiments may be combined as appropriate.

What is claimed is:

1. An electronic apparatus comprising:
an image data receiver configured to receive image data captured by a camera;
a color data acquisition module configured to acquire color data of a first color that is close to a complementary color of a second color of the received image data; and
a image display configured to display a first image based on the received image data and to display a second image adjacent to the first image based on the acquired color data.

2. The electronic apparatus of claim 1, wherein the second image comprises the first color that is close to the complementary color of a third color of the first image.

3. The electronic apparatus of claim 1, the color data acquisition module is configured to acquire the color data from a plurality of color data that are provided in advance.

4. The electronic apparatus of claim 1, further comprising an average color calculator configured to calculate an average color of the received image data.

5. The electronic apparatus of claim 1, wherein the second image is configured to vary according to an average color of the received image data.

6. The electronic apparatus of claim 4, wherein the color data acquisition module is configured to acquire color data of a third color that is close to a complementary color of the calculated average color.

7. The electronic apparatus of claim 1, further comprising A camera,
wherein the camera is next to the video display module.

8. The electronic apparatus of claim 1, further comprising:
an illumination sensor configured to acquire illuminance information; and
a luminance adjusting module configured to adjust luminance of the video display module according to the acquired illuminance information.

9. A display method comprising:
receiving image data captured by a camera;
acquiring color data of a first color that is close to a complementary color of a second color of the received image data; and
displaying a first image based on the received image data and to display a second image adjacent to the first image based on the acquired color data.
